(19) United States
(12) Patent Application Publication
(10) Pub. No.: US 2006/0182110 A1
(43) Pub. Date: Aug. 17, 2006

(54) Apparatus, system, and method for fibre channel device addressing

(76) Inventors: Matthew David Bomhoff, Tucson, AZ (US); Brian James Cagno, Tucson, AZ (US); John Charles Elliott, Tucson, AZ (US); Robert Akira Kubo, Tucson, AZ (US); Gregg Steven Lucas, Tucson, AZ (US)

Correspondence Address: KUNZLER & ASSOCIATES, 8 EAST BROADWAY, SUITE 600, SALT LAKE CITY, UT, 84111, US

(21) Appl. No.: 11/061,955

(22) Filed: Feb. 17, 2005

(51) Int. Cl. H04L 12/56; H04L 12/28

(52) U.S. Cl. 370/392

(57) ABSTRACT

An apparatus, system, and method are disclosed for fibre channel device addressing. The apparatus includes a mapping module, a receiving module, and an assigning module configured to execute the necessary steps of defining an address assignment map to associate a single logical address with a physical device, receive a request for the logical address defined for the physical device by the address assignment map, and consistently assign the logical address defined by the address assignment map to the physical device. Beneficially, the apparatus, system, and method provide for consistent and reliable fibre channel device addressing.

### BACKGROUND OF THE INVENTION

1. Field of the Invention

This invention relates to Fibre Channel Arbitrated Loop (FC-AL) component configuration and more particularly relates to addressing of FC-AL devices.

2. Description of the Related Art

Recent technical developments have created a need for extremely fast data links. High performance computing devices and data connections have become the focus of much attention in the data communications industry. Performance improvements have resulted in increasingly data-intensive and high-speed networking applications. However, the existing network interconnects between computers and I/O devices are unable to run at the speeds needed to satisfy the increased need for data handling.

Typically, data communication connections are configured as either channels or networks. A channel provides a direct or switched point-to-point connection between the communicating nodes. A channel is typically hardware-intensive and communicates data at high speeds with low resource overhead. A network configuration is an aggregation of distributed nodes with a protocol that controls interactions among the nodes. A network is software-intensive, and consequently a relatively high resource overhead. Although networks are capable of handling a wider variety of communication tasks than channels, the high resource overhead greatly reduces data transmission rates.

One recent solution to this increasing demand for data handling capability is FC-AL. FC-AL has been developed to provide a practical, inexpensive, and readily expandable mode of transferring data at extremely high rates between workstations, mainframes, supercomputers, storage devices, and other peripheral computing devices. FC-AL combines the use of high performance hardware with versatile software for a hybrid channel-network communication mode.

One common environment wherein FC-AL connections are utilized is a data storage environment. For example, an application server may interface with several data storage devices. The application server may require high data rate access to remotely located modular data storage devices in order to store large amounts of application transaction data. A channel configuration is desirable in order to achieve the required high data rates. However, the versatility of a network configuration is beneficial when working with remote devices. In such an example, an FC-AL connection is optimal, because it provides extremely high data rates while achieving greater versatility than common channel connections.

The remote storage devices may be connected in a modular configuration. Each module may contain multiple FC-AL ports to allow access to the storage device. In some instances, an FC-AL fabric is capable of supporting 127 or more FC-AL ports. In such instances, device addressing may become inconsistent. In a typical system, a loop initialization process occurs each time an FC-AL event occurs on the FC-AL fabric.

For example, if an FC-AL storage device is replaced due to failure, each FC-AL component of the fabric takes part in a loop address arbitration process triggered by the event. In such an example, the loop initialization process typically includes three phases. First, each FC-AL component checks for its previously assigned address. The previously assigned address is typically stored in a volatile memory on the FC-AL component. If the previously assigned address is unavailable, the FC-AL component attempts to obtain a preferred address. Typically the preferred address is determined by hardwired select (SEL) lines. The SEL lines are generally directly coupled to an FC-AL enclosure, and removable coupled to the FC-AL component. Address assignment based on the preferred address indicated by the SEL lines is typically referred to as hard addressing. In hard addressing mode, an address map is passed from one FC-AL device to the next for address selection. If the preferred address identified by the SEL lines is available in the map, the FC-AL device claims the address. If the preferred address is not available (for example, in conflict with an already existing address), the FC-AL component obtains an address in a soft addressing mode. In soft addressing mode, the address map is passed from one FC-AL component to the next, and each FC-AL component selects an available address, updates the map, and passes the map on to the next FC-AL component.

One problem with the typical addressing method described above is addressing inconsistencies. For example, an FC-AL component may be given an address ‘10’ wherein the address may represent the preferred hard address. In this example, the first digit represents the enclosure number, and the second number represents the port number within the enclosure. For example, the address ‘10’ may represent the hard address for port ‘0’ within enclosure ‘1’. A new FC-AL enclosure may be introduced to the FC-AL network. If a hardware fault occurs, or the enclosure is configured incorrectly, the preferred hard address for port ‘0’ of the second enclosure may also be ‘10’. In this example, two separate FC-AL components may attempt to obtain the address ‘10’. If the new component obtains the address ‘10’ before the previously addressed component during a loop initialization process, the previously address component will be forced to obtain a new address during the soft addressing phase of the loop initialization process. In this case, the component addressing may not be consistent. The addressing convention presented in the example above is not typical for FC-AL systems. Typically an FC-AL system address may include seven bits in order to define 128 unique addresses.

From the foregoing discussion, it should be apparent that a need exists for an apparatus, system, and method that address a fibre channel device according to a predefined logical address to physical device correlation. Beneficially, such an apparatus, system, and method would provide a consistent addressing scheme for FC-AL components within an FC-AL network. Consistent addressing can improve the efficiency of the loop initialization process and reduce the possible confusion and complexity associated with FC-AL component fault detection and debug.

### SUMMARY OF THE INVENTION

The present invention has been developed in response to the present state of the art, and in particular, in response to the problems and needs in the art that have not yet been fully solved by currently available fibre channel networking solutions. Accordingly, the present invention has been developed to provide an apparatus, system, and method for fibre channel device addressing that overcome many or all of the above-discussed shortcomings in the art.

The apparatus for fibre channel device addressing is provided with a logic unit containing a plurality of modules configured to functionally execute the necessary steps of defining an address assignment map to associate a single logical address with a physical device, receive a request for the logical address defined for the physical device by the address assignment map, and consistently assign the logical address defined by the address assignment map to the physical device. These modules in the described embodiments include a mapping module, a receiving module, and an assigning module.

In one embodiment, the mapping module is configured to define an address assignment map to associate a single logical address with a physical device. Additionally, the mapping module may include a coordination module configured to coordinate address assignment map definition between one or more fibre channel devices, wherein the coordination takes place between one or more local processors. In one embodiment, the operation to define the address assignment map is performed without requiring hardwired select (SEL) line information.

In one embodiment, the receiving module is configured to receive a request for the logical address defined for the physical device by the address assignment map. Additionally, the receiving module may further comprise a detection module configured to detect fibre channel network initialization sequence traffic and reroute the traffic to a local processor. In another embodiment, the apparatus may further comprise a transition module configured to skip a hard addressing mode and transition directly to a soft addressing mode in response to fibre channel network initialization.

In one embodiment, the assigning module is configured to consistently assign the logical address defined by the address assignment map to the physical device. The assigning module may further comprise an alteration module configured to alter an address selection map in accordance with the requirements of the address assignment map, wherein the alterations provide a consistent address for selection by the fibre channel device. Additionally, the assigning module may further comprise a presentation module configured to present a single address in an address selection map for selection by the fibre channel device.

A system of the present invention is also presented to address a fibre channel device. In one embodiment, the system includes an enclosure configured to house a fibre channel device, a fibre channel device mechanically coupled to the enclosure, a fibre channel device switch coupled to the fibre channel device, and a local processor electrically coupled to the fibre channel switch, and configured to define an address assignment map to associate a single logical address with a physical device, receive a request for the logical address defined for the physical device by the address assignment map, and consistently assign the logical address defined by the address assignment map to the physical device.

A method of the present invention is also presented for fibre channel device addressing. The method in the disclosed embodiments substantially includes the steps necessary to carry out the functions presented above with respect to the operation of the described apparatus and system. Specifically, defining an address assignment map to associate a single logical address with a physical device, receiving a request for the logical address defined for the physical device by the address assignment map, and consistently assigning the logical address defined by the address assignment map to the physical device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not, therefore, to be considered to be limiting of its scope, the invention will be described and explained with additional specificity and detail through the use of the accompanying drawings, in which:

FIG. 1 is a schematic block diagram illustrating one embodiment of a system for fibre channel device addressing;

FIG. 2 is a schematic block diagram illustrating one embodiment of an apparatus for fibre channel device addressing;

FIG. 3 is a detailed schematic block diagram illustrating one embodiment of an apparatus for fibre channel device addressing;

FIG. 4 is a schematic flow chart diagram illustrating one embodiment of a method for fibre channel device addressing;

FIG. 5 is a detailed schematic flow chart diagram illustrating one embodiment of a method for fibre channel device addressing.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

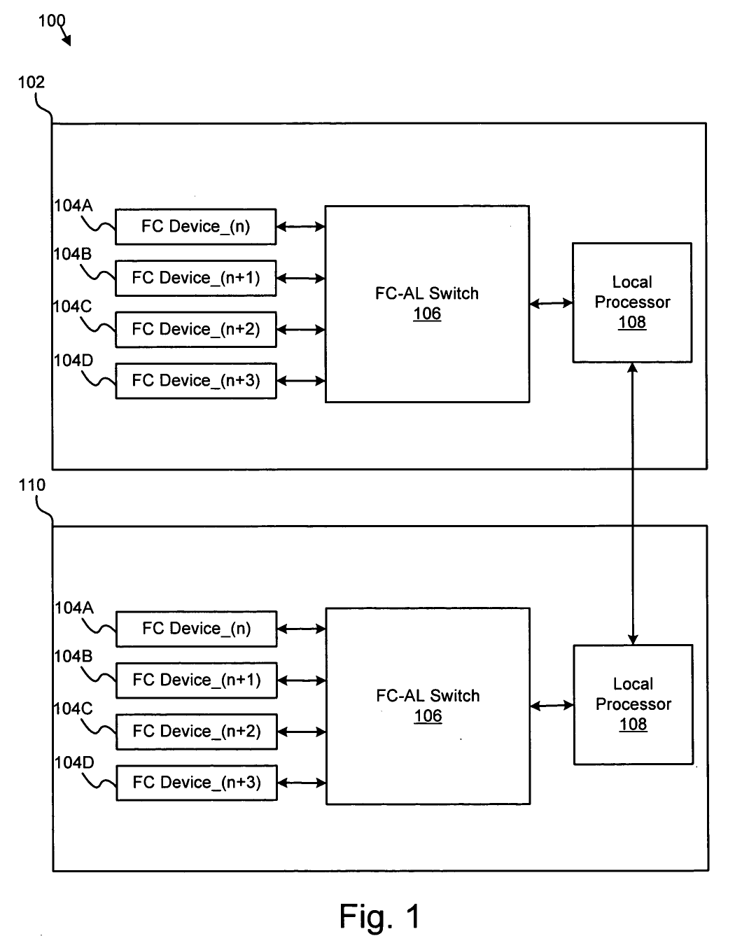

FIG. 1 depicts a schematic block diagram of a system 100 for FC-AL device addressing. In one embodiment, the system 100 includes an FC-AL device enclosure 102. The enclosure 102 may house one or more FC-AL devices 104A-D, an FC-AL Switch 106, and a local processor 108. In certain embodiments, the system 100 may include multiple FC-AL device enclosures 102, 110. For example, the system 100 may include a second FC-AL device enclosure 110. The second FC-AL device enclosure 110 may also include FC-AL devices 104A-D, an FC-AL switch 106, and a local processor 108.

In one embodiment, the enclosure 102 may house one or more FC-AL devices 104. Although for purposes of illustration four FC-AL devices 104A-D are depicted, the enclosure 102 may house a variable number of FC-AL devices 104. In certain embodiments, the enclosure 102 may provide mechanical support, power, and fibre channel network switching capability for the FC-AL devices 104. In one embodiment, the enclosure 102 may include a housing and framework to provide mechanical support for the FC-AL devices 104. The enclosure 102 may additionally include a pluggable backplane with attached connectors and cables to provide power, fibre channel interfaces, hard addressing SEL lines, and the like. Additionally, the enclosure 102 may house the FC-AL switch 106 and the local processor 108. Similarly, the enclosure 102 may provide data connection, power, and mechanical support for the FC-AL switch 106 and the local processor 108.

An FC-AL device 104 may include a data processing device, a data storage device, a data handling device, a data networking device, and the like. For example, the enclosure 102 may house data storage disks 104. The data storage disks 104 may include fibre channel data I/O interfaces. In one embodiment, the enclosure 102 may house a plurality of data storage disks 104A-D, wherein each storage disk 104A-D is included in an FC-AL network and accessibly through an FC-AL switch 106.

In one embodiment, the FC-AL switch 106 may provide a switchable FC-AL interface for the FC-AL devices 104A-D. Each of the FC-AL devices 104A-D may be connected to a unique I/O port on the FC-AL switch 106. In one embodiment, the FC-AL devices 104A-D require unique network addresses for data communications. For example, FC-AL device_(n) 104A may be connected to port ‘0’ of the FC-AL switch 106. Additionally, the FC-AL devices 104B-D may be connected to ports ‘1’ through ‘3’ respectively. In this example, each one of the FC-AL devices 104 A-D requires a unique address so that the FC-AL switch 106 can accurately route the FC-AL network data to the individual FC-AL devices 104A-D.

In certain embodiments, the local processor 108 may control FC-AL network operations. In one embodiment, the local processor 108 may control the FC-AL loop initialization process. Additionally, the local processor 108 may perform the operations of defining an address assignment map to associate a single logical address with a physical FC-AL device 104, receive a request for the logical address defined for the physical device by the address assignment map, and consistently assign the logical address defined by the address assignment map to the physical device 104.

Additionally, the local processor 108 of the first enclosure 102 may coordinate with the local processor 108 of the second enclosure 110 to define the logical address assignment map. The term address assignment map, as used herein, describes the logical correlation structure created by the local processors 108 prior to initialization of a loop initialization process, and defines the prescribed logical address/physical device 104 relationship to be applied. In one embodiment, the address assignment map is persistent as long as the FC-AL system is powered on. In another embodiment, each local processor 108 maintains an individual copy of the address assignment map. The address assignment map may be used to determine the logical address assigned to each physical device 104. Details of these operations are discussed further in the paragraphs that follow.

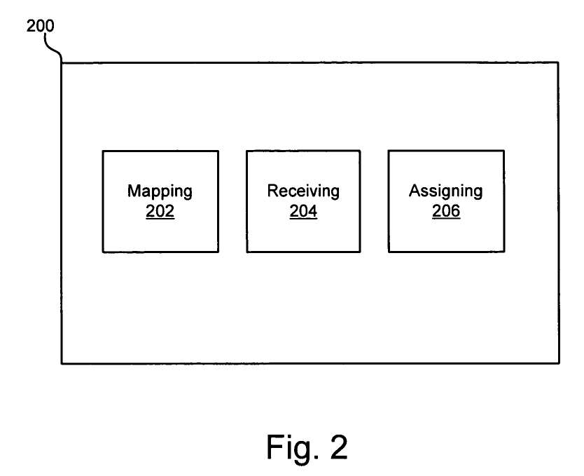

FIG. 2 depicts a schematic block diagram of an apparatus 200 for FC-AL device addressing. In one embodiment, the apparatus 200 may contain a plurality of modules configured to functionally execute the necessary steps of defining an address assignment map to associate a single logical address with a physical device 104, receive a request for the logical address defined for the physical device 104 by the address assignment map, and consistently assign the logical address defined by the address assignment map to the physical device 104. These modules may include a mapping module 202, a receiving module 204, and an assigning module 206. In one embodiment, the apparatus 200 may be integrated with the local processor 108.

In one embodiment, the mapping module 202 is configured to define an address assignment map to associate a single logical address with a physical device 104. For example, the mapping module 202 may determine the logical addresses based on a port identifier of each port on the FC-AL switch 106. In one embodiment, the port identifier is determined by a port control register on the FC-AL switch 106, wherein the local processor 108 communicates with the port control register. In another embodiment, the mapping module may determine the logical addresses based on a predefined priority scheme, geographical locations, or the like. In one embodiment, the address assignment map is a logical data structure, table, file, or the like stored in a memory location associated with the local processor 108.

In one embodiment, the receiving module 204 receives a request for the logical address defined for the physical device 104 by the address assignment map. If a device is added or removed from the system, or if a device in the system becomes unavailable or comes back online, a loop initialization process may be initiated. In one embodiment, each FC-AL device 104 on the FC-AL network will require an address as part of the loop initialization process. Each device 104 may request an address from the local processor 108. In certain embodiments, the receiving module 204 may enable the local processor 108 to receive and handle such requests.

In one embodiment, the assigning module 206 consistently assigns the logical address defined by the address assignment map to the physical device 104. For example, the mapping module 202 may assign the address ‘00000001’ to FC-AL device_(n) 104A of the first enclosure 102. In one embodiment, the assigning module 206 consistently assigns the address ‘00000001’ to FC-AL device_(n) 104A of the first enclosure 102 in response to each address request received by the receiving module 204 from the FC-AL device 104A.

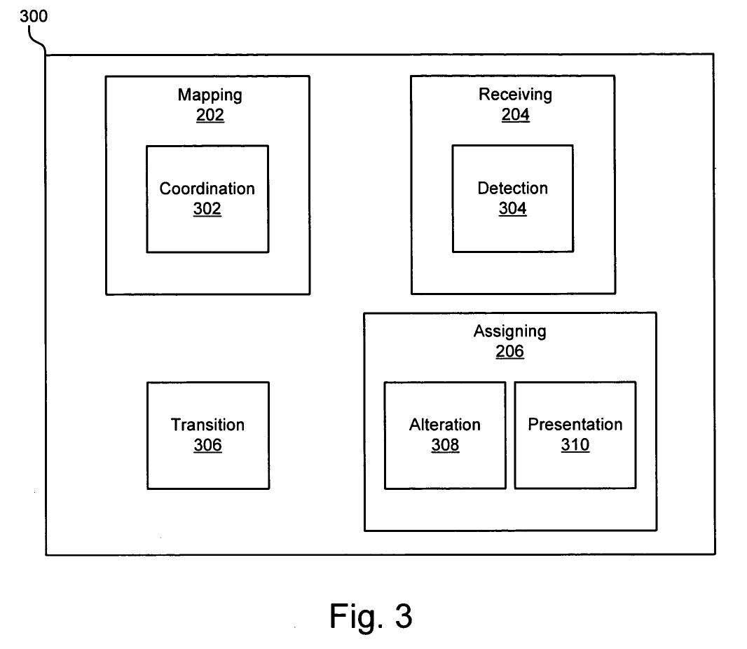

FIG. 3 is a detailed schematic block diagram illustrating one embodiment of an apparatus 300 for FC-AL device 104 addressing. In one embodiment, the apparatus 300 includes the mapping module 202, the receiving module 204, and the assigning module 206 as described in relation to FIG. 3. Additionally, the apparatus 300 may include a coordination module 302, a detection module 304, an alteration module 308, a presentation module 310, and a transition module 306.

In one embodiment, the mapping module 202 includes a coordination module 302 configured to coordinate address assignment map definition between one or more FC-AL devices 104, wherein the coordination takes place between one or more local processors 108. In one embodiment, each FC-AL device may have an independent local processor 108. Alternatively, the FC-AL system may include multiple packs of FC-AL devices 104 or multiple FC-AL device enclosures 102, 110 each including an independent local processor 108. In such an embodiment, coordination between the independent local processors 108 is required for address assignment map definition. In one embodiment, the coordination modules 302 of each local processor 108 may be electrically connected for coordination. Alternatively, the coordination module 302 may utilize the FC-AL data network for coordination of the local processors 108.

In one embodiment, the receiving module 204 includes a detection module 304 configured to detect FC-AL network initialization sequence traffic and reroute the traffic to a local processor 108. In one embodiment, FC-AL network initialization traffic is the address arbitration traffic associated with a loop initialization process. The detection module 304 may detect the loop initialization process traffic, and reroute address requests to the local processor 108. In such an embodiment, the previously assigned addressing mode and the hard addressing mode are skipped, and the system is automatically forced into soft addressing mode. In one embodiment, soft addressing mode is a software defined addressing mode. The receiving module 204 then receives the address requests, and triggers the assigning module 206 to handle the address requests.

In one embodiment, the apparatus 300 additionally includes a transition module 306 configured to transition directly to a soft addressing mode in response to fibre channel network initialization. In one embodiment, the transition module 306 forces the FC-AL devices 104 into soft addressing mode in response to the detection module 304 detecting FC-AL address arbitration traffic. The transition module 306 may force the FC-AL devices 104 into soft addressing mode by bypassing signals associated with the SEL lines. Alternatively, the transition module 306 may include FC-AL arbitration traffic control logic configured to return reject address request associated with hard addressing mode.

In one embodiment, the assigning module 206 includes an alteration module 308 configured to alter an address selection map in accordance with the requirements of the address assignment map, wherein the alterations provide a consistent address for selection by the FC-AL device 104. As used herein, the address selection map is the Arbitrated Loop Physical Address (ALPA) map typically used in standard FC-AL address arbitration during the soft addressing mode. However, the alteration module 308 modifies the ALPA map in such a way that the only address available for the requesting FC-AL device 104 to select is the address assigned to the FC-AL device 104 by the address assignment map.

In one embodiment, the assigning module 206 additionally includes a presentation module 310 configured to present a single address in an address selection map for selection by the FC-AL device 104. Again the term address selection map refers to an ALPA address map of the art. However, the ALPA map presented by the presentation module 310 has been altered by the alteration module 308 to contain only a single available address for each requesting device 104. Each time the FC-AL device 104 requests an address, it will have only one choice available in the ALPA map, that choice being the address prescribed by the address assignment map. Therefore, the addressing scheme may remain constant with respect to the individual FC-AL devices 104.

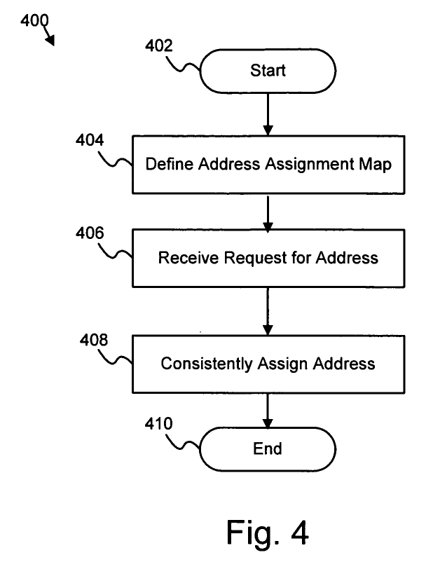

FIG. 4 is a schematic flow chart diagram illustrating one embodiment of a method 400 for FC-AL device 104 addressing. In one embodiment, the method 400 starts 402 when the mapping module 202 defines 404 an address assignment map to associate a single logical address with a physical device 104. Then the receiving module 204 receives 406 a request for the logical address defined for the physical device 104 by the address assignment map. Finally, the assigning module 206 consistently assigns 408 the logical address defined by the address assignment map to the physical device 104, and the method 400 ends 410.

For example, if the first enclosure 102 is configured with four FC-AL devices 104A-D, the mapping module 202 may assign seven bit addresses corresponding to the address numbers ‘0’-‘3’ to the FC-AL devices 104A-D respectively. The assigning module 206 may then consistently assign the address assigned in the address assignment map to the FC-AL devices 104A-D in response to each request from the devices 104A-D.

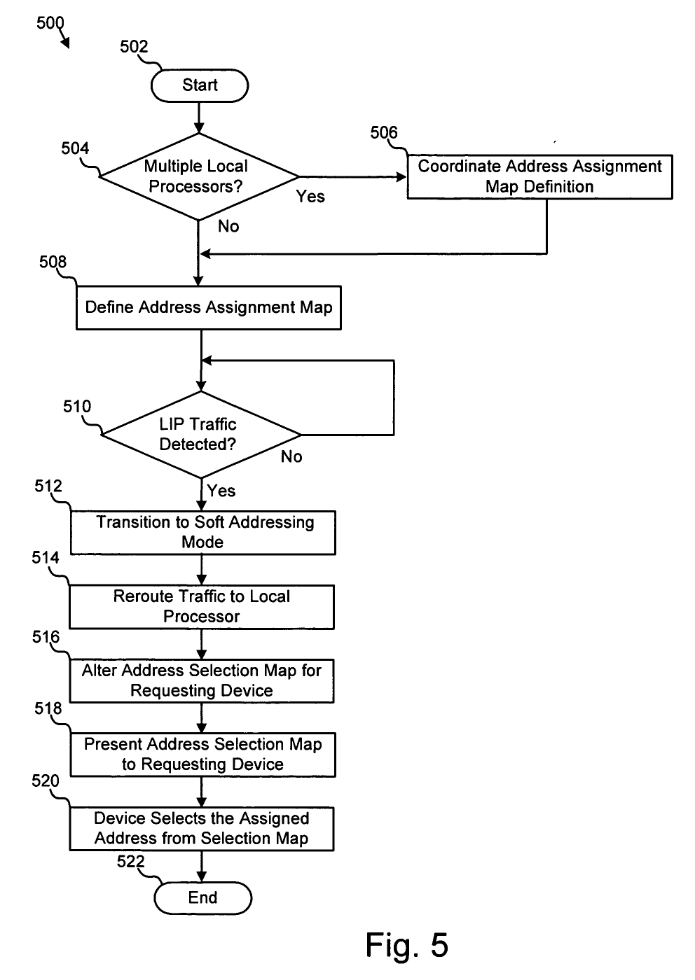

FIG. 5 is a detailed schematic flow chart diagram illustrating one embodiment of a method 500 for FC-AL device 104 addressing. In one embodiment, the method 500 starts 502 by determining 504 if multiple local processors 108 are present in the FC-AL network. If multiple local processors 108 are present 504, the coordination module 302 coordinates 506 the definition of the address assignment map between the mapping modules 202. If multiple local processors are not present 504, then no coordination 506 is required.

When either the coordination 506 is complete, or it is determined 504 that no coordination is required, the mapping module 202 defines 508 an address assignment map. With the address assignment map defined 508, the system waits until LIP traffic is detected 510 by the detection module 304. If LIP traffic is detected 510, the transition module 306 skips the hard addressing mode and transitions 512 directly into soft addressing mode. The detection module 304 may then reroute 514 LIP traffic to the local processor 108. In one embodiment, the receiving module 204 receives 406 the request for addressing from the FC-AL device 104.

When the request for addressing has been received 406, the alteration module 308 then alters 516 the address selection map (ALPA map) according to the address assignment map requirements. In one embodiment, the alteration module 308 makes only a single address available in the ALPA map for selection by the FC-AL device 104. The presentation module 310 then presents 518 the ALPA map to the requesting FC-AL device 104. In another embodiment, the same address is presented 518 to the FC-AL device 104 in response to each address request from the FC-AL device 104. The FC-AL device 104 then selects 520 the assigned address from the ALPA map, and the method ends 522.

For example, an FC-AL system 100 may include two FC-AL device enclosures 102, 110. Each enclosure 102, 110 may house four FC-AL storage disks 104A-D and a local processor 108 for FC-AL network control. Each local processor 108 may include an integrated apparatus 300 for FC-AL device 104 addressing configured to carry out the method 500. In this example, the coordination module 302 may coordinate 506 between the local processors 108 on each of the enclosures 102, 110. Then the mapping module 202 of each local processor 108 may define 508 addresses for the FC-AL devices 104A-D within the local enclosure 102, 110. When the FC-AL storage devices 104 are introduced to the FC-AL network, an Loop intialization process may handle FC-AL device 104 addressing arbitration. The detection module 304 may then detect 510 the LIP traffic.

In the example above, the transition module 306 may force 512 the arbitration into soft addressing mode, and the detection module 304 may reroute 514 the LIP traffic to the local processor 108. When the receiving module 204 receives 406 the addressing request, the alteration module 308 may alter 516 the ALPA map to indicate only a single address available uniquely associated with each FC-AL device 104A-D. The presentation module 310 may then present the ALPA map to the requesting FC-AL device 104. When the device selects the assigned address from the selection map, the method ends 522 until new LIP traffic is detected 510.

As described above, one clearly novel feature of the present invention is the ability to consistently present only a single available address to each requesting FC-AL device 104. Such a feature provides the advantageous capability of assigning a persistent address to each FC-AL device on the FC-AL network. Beneficially, the apparatus, system, and method described above enable an FC-AL network technician to easily identify an FC-AL network device 104 by the address assigned to the device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to address a fibre channel device, the apparatus comprising:
a mapping module configured to define an address assignment map to associate a single logical address with a physical device;
a receiving module configured to receive a request for the logical address defined for the physical device by the address assignment map; and
an assigning module configured to consistently assign the logical address defined by the address assignment map to the physical device.

2. The apparatus of claim 1, wherein the mapping module further comprises a coordination module configured to coordinate address assignment map definition between one or more fibre channel devices, wherein the coordination takes place between one or more local processors.

3. The apparatus of claim 1, wherein the receiving module further comprises a detection module configured to detect fibre channel network initialization sequence traffic and reroute the traffic to a local processor.

4. The apparatus of claim 1, wherein the assigning module further comprises an alteration module configured to alter an address selection map in accordance with the requirements of the address assignment map, wherein the alterations provide a consistent address for selection by the fibre channel device.

5. The apparatus of claim 1, wherein the assigning module further comprises a presentation module configured to present a single address in an address selection map for selection by the fibre channel device.

6. The apparatus of claim 1, wherein the operation to define the address assignment map is performed without requiring hardwired select (SEL) line information.

7. The apparatus of claim 1, further comprising a transition module configured to skip a hard addressing mode and transition directly to a soft addressing mode in response to fibre channel network initialization.

8. A system to address a fibre channel device, the system comprising:
an enclosure configured to house a fibre channel device;
a fibre channel device mechanically coupled to the enclosure;
a fibre channel device switch coupled to the fibre channel device; and
a local processor electrically coupled to the fibre channel switch, and configured to:
define an address assignment map to associate a single logical address with a physical device;
receive a request for the logical address defined for the physical device by the address assignment map; and
consistently assign the logical address defined by the address assignment map to the physical device.

9. The system of claim 8, wherein the local processor is further configured to coordinate address assignment map definition between one or more fibre channel devices, wherein the coordination takes place between one or more local processors.

10. The system of claim 8, wherein the local processor is further configured to detect fibre channel network initialization sequence traffic and reroute the traffic to a local processor.

11. The system of claim 8, wherein the local processor is further configured to alter an address selection map in accordance with the requirements of the address assignment map, wherein the alterations provide a consistent address for selection by the fibre channel device.

12. The system of claim 8, wherein the local processor is further configured to present a single address in an address selection map for selection by the fibre channel device.

13. The system of claim 8, wherein the local processor is further configured to skip a hard addressing mode an transition directly to a soft addressing mode in response to fibre channel network initialization.

14. A signal bearing medium tangibly embodying a program of machine-readable instructions executable by a digital processing apparatus to perform an operation to address a fibre channel device, the operation comprising:
defining an address assignment map to associate a single logical address with a physical device;
receiving a request for the logical address defined for the physical device by the address assignment map; and
consistently assigning the logical address defined by the address assignment map to the physical device.

15. The signal bearing medium of claim 14, wherein the operation to define further comprises an operation to coordinate address assignment map definition between one or more fibre channel devices, wherein the coordination takes place between one or more local processors.

16. The signal bearing medium of claim 14, wherein the operation to receive further comprises an operation to detect fibre channel network initialization sequence traffic and reroute the traffic to a local processor.

17. The signal bearing medium of claim 14, wherein the operation to assign further comprises an operation to alter an address selection map in accordance with the requirements of the address assignment map, wherein the alterations provide a consistent address for selection by the fibre channel device.

18. The signal bearing medium of claim 14, wherein the operation to assign further comprises an operation to present a single address in an address selection map for selection by the fibre channel device.

19. The signal bearing medium of claim 14, wherein the operation to define the address assignment map is performed without requiring hardwired select (SEL) line information.

20. The signal bearing medium of claim 14, wherein the instructions further comprise an operation to skip a hard addressing mode an transition directly to a soft addressing mode in response to fibre channel network initialization.
